(19) United States
(12) Patent Application Publication
(10) Pub. No.: US 2025/0274948 A1
(43) Pub. Date: Aug. 28, 2025

(54) SYSTEM MESSAGE TRANSMISSION METHOD AND DEVICE, COMMUNICATION NODE, AND STORAGE MEDIUM

(71) Applicant: ZTE CORPORATION, Shenzhen (CN)

(72) Inventors: Youjun HU, Shenzhen (CN); Bo DAI, Shenzhen (CN); Mengzhu CHEN, Shenzhen (CN); Luanjian BIAN, Shenzhen (CN); Kun LIU, Shenzhen (CN); Weiwei YANG, Shenzhen (CN)

(21) Appl. No.: 18/998,808

(22) PCT Filed: Mar. 30, 2023
(86) PCT No.: PCT/CN2023/085151

§ 371 Date: Jan. 27, 2025

(30) Foreign Application Priority Data
Aug. 1, 2022 (CN) 202210918311.0

(51) Int. Cl. H04W 72/231; H04L 5/00; H04W 72/0446; H04W 72/0453; H04W 72/1273

(52) U.S. Cl. CPC H04W 72/231; H04L 5/0044; H04W 72/0446; H04W 72/0453; H04W 72/1273

(57) ABSTRACT

Provided are a system message transmission method and device, a communication node, and a storage medium. The method includes determining transmission information of a system message; and transmitting the system message according to the transmission information.

This application claims priority to Chinese Patent Application No. 202210918311.0 filed with the China National Intellectual Property Administration (CNIPA) on Aug. 1, 2022, the disclosure of which is incorporated herein by reference in its entirety.

### TECHNICAL FIELD

The present application relates to the field of communication technology, in particular, a system message transmission method and device, a communication node, and a storage medium.

### BACKGROUND

After a terminal device resides in a cell, the terminal device can learn about the operating state of the cell by receiving a system message. The system message includes the main information block (MIB) and the system information block (SIB), and the SIB may include the SIB1 and other system information (OSI).

In narrowband communication scenarios, the probability of a terminal device correctly receiving a system message is relatively low. Therefore, how to ensure that terminal devices in narrowband communication scenarios can correctly receive system messages has become an urgent problem to be solved by those skilled in the art.

### SUMMARY

The present application provides a system message transmission method and device, a communication node, and a storage medium.

In a first aspect, an embodiment of the present application provides a system message transmission method. The method includes the following:

Transmission information of a system message is determined.

The system message is transmitted according to the transmission information.

In a second aspect, an embodiment of the present application provides a system message transmission method. The method includes the following:

Transmission information of a system message is acquired.

The system message is received according to the transmission information.

In a third aspect, an embodiment of the present application provides a system message transmission device. The device includes a determination module and a transmission module.

The determination module is configured to determine transmission information of a system message.

The transmission module is configured to transmit the system message according to the transmission information.

In a fourth aspect, an embodiment of the present application provides a system message transmission device. The device includes an acquisition module and a receiving module.

The acquisition module is configured to acquire transmission information of a system message.

The receiving module is configured to receive the system message according to the transmission information.

In a fifth aspect, an embodiment of the present application provides a communication node. The communication node includes a memory and a processor. The memory stores a computer program. The processor, when executing the computer program, is configured to implement the operations of the methods described in the first aspect and the second aspect of the embodiments of the present application.

In a sixth aspect, an embodiment of the present application provides a storage medium. The storage medium stores a computer program that, when executed by a processor, causes the processor to implement the operations of the method described in the first aspect and the second aspect of the embodiments of the present application.

The preceding embodiments and other aspects of the present application and implementations thereof are described in more detail in the brief description of drawings, detailed embodiments, and claims.

### BRIEF DESCRIPTION OF DRAWINGS

FIG. 1 is a diagram illustrating the structure of a wireless communication system according to an embodiment of the present application.

FIG. 2 is a diagram illustrating a process for monitoring a system message according to an embodiment of the present application.

FIG. 3 is a flowchart of a system message transmission method according to an embodiment of the present application.

FIG. 4 is another flowchart of the system message transmission method according to an embodiment of the present application.

FIG. 5 is a diagram of a mapping manner for a system message according to an embodiment of the present application.

FIG. 6 is a diagram of another mapping manner for the system message according to an embodiment of the present application.

FIG. 7 is yet another mapping manner for the system message according to an embodiment of the present application.

FIG. 8 is yet another mapping manner for the system message according to an embodiment of the present application.

FIG. 9 is yet another mapping manner for the system message according to an embodiment of the present application.

FIG. 10 is a diagram illustrating the structure of a system message transmission device according to an embodiment of the present application.

FIG. 11 is a diagram illustrating another structure of the system message transmission device according to an embodiment of the present application.

FIG. 12 is a diagram illustrating the structure of a communication node according to an embodiment of the present application.

### DETAILED DESCRIPTION

It is to be understood that the specific embodiments described herein are intended to explain the present application and not to limit the present application. Embodiments of the present application are described hereinafter in detail in conjunction with drawings.

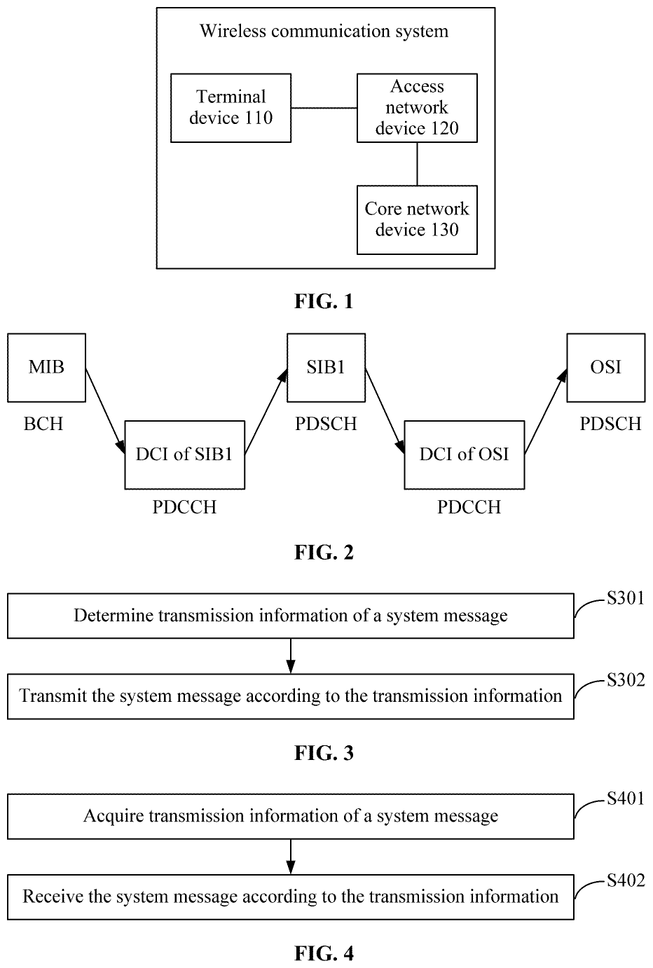

The system message transmission methods provided in the embodiments of the present application may be applied to various types of wireless communication systems, such as a Long-Term Evolution (LTE) system, a 4th-generation mobile communication technology (4G) system, a 5th-generation mobile communication technology (5G) system, an LTE and 5G hybrid architecture system, a 5G New Radio (NR) system, and new communication systems emerging in future communication development, for example, a 6th-generation mobile communication technology (6G) system. FIG. 1 is a diagram illustrating the networking of a wireless communication system according to an embodiment. As shown in FIG. 1, the wireless communication system includes a terminal device 110, an access network device 120, and a core network device 130.

The terminal device 110 may be a device having radio transceiving functions. The device may be deployed on land (such as being indoor or outdoor, handled, wearable, or vehicle-mounted); may be deployed on water (such as in ships); and may also be deployed in the air (such as in airplanes, balloons, and satellites). Examples of some terminal devices 110 are as follows: User Equipment (UE), a mobile phone, a mobile station, a tablet computer, a notebook computer, an ultra-mobile personal computer (UMPC), a handheld computer, a netbook, a personal digital assistant (PDA), and other user equipment that can be networked; a virtual reality (VR) terminal, an augmented reality (AR) terminal, a wireless terminal in industrial control, a wireless terminal in self-driving, a wireless terminal in remote medical, a wireless terminal in a smart grid, a wireless terminal in transportation safety, a wireless terminal in a smart city, and a wireless terminal in a smart home; an IoT node in the Internet of Things (IoT); an in-vehicle communication apparatus in the Internet of Vehicles; an entertainment and game device or system; or a global positioning system device. The embodiments of the present application do not limit the specific form of the terminal device.

The access network device 120 is an access device through which the terminal device 110 wirelessly accesses the wireless communication system. The access network device 120 may be a base station, an evolved base station (evolved NodeB, eNB, or eNodeB) in Long Term Evolution Advanced (LTE-A), a transmission reception point (TRP), a base station in the 5G mobile communication system, a next generation base station (next generation NodeB or gNB), a base station in a future mobile communication system, or an access node in a Wireless Fidelity (Wi-Fi) system. The base station may include various network side devices such as a macro base station, a micro base station, a Home Node B, a radio remote, a router, a Wi-Fi device, or a primary cell and a secondary cell, and location management function (LMF) devices. The access network device 120 may also be a module or unit that performs part of functions of the base station, for example, a central unit (CU) or a distributed unit (DU). The embodiments of the present application do not limit the specific technology and the specific device configuration used by the access network device. Additionally, the access network device may be referred to as a cell.

The core network device 130 may include an access and mobility management network element and a session management network element. Exemplarily, the terminal device 110 may access the core network through the access network device 120, thereby enabling data transmission.

The process of receiving a system message by a terminal device is explained as follows:

As shown in FIG. 2, after receiving the MIB on the broadcast channel (BCH), the terminal device may receive the downlink control information (DCI) that schedules the SIB1 on the specified physical downlink control channel (PDCCH) according to the information in the MIB. Then, the terminal device may receive the SIB1 on the physical downlink shared channel (PDSCH) according to the content of the DCI. Subsequently, according to the information in the SIB1, the terminal device may receive the DCI that schedules OSI on the specified PDCCH and then receive OSI on the PDSCH according to the content of the DCI.

Currently, in some narrowband communication scenarios, the success rate of a terminal device receiving a system message is relatively low. Therefore, the embodiments of the present application aim to improve the success rate of the terminal device receiving a system message in such communication scenarios through technical means such as repeated transmission of the system message, restricting frequency domain resource indication of the system message, redefining the DCI for scheduling the system message, and applying specific mapping manners to map the system message.

Next, the technical solutions provided in the embodiments of the present application are introduced in detail.

FIG. 3 is a flowchart of a system message transmission method according to an embodiment of the present application. As shown in FIG. 3, the method provided in this embodiment is applicable to an access network device. In this example, the access network device may be a cell. The method may include the following:

In S301, transmission information of a system message is determined.

In S302, the system message is transmitted according to the transmission information.

In an embodiment, the system message may be repeatedly transmitted according to the transmission information. In the case of repeatedly transmitting the system message, the preceding transmission information may include at least one of the following: the period of repetition transmissions of the system message, the number of repetition transmissions of the system message, the time window for repetition transmissions of the system message, position information for repetition transmissions of the system message, physical downlink control channel (PDCCH) occasion information, OSI message type information, system message index information, monitoring time period information within a system message window, monitoring position information within a system message window, or periodic pattern information for the system message.

In an embodiment, the transmission information may include terminal type information supported by a cell. In the case where the cell allows a first type of terminal to access, the frequency domain bandwidth of the system message transmission of the first type of terminal may be limited, that is, the frequency bandwidth of the system message transmission does not exceed the maximum bandwidth of the first type of terminal; the mapping manner of a virtual resource block (RB) to a physical RB of the system message is non-interleaved; and DCI scheduling a PDSCH carrying the system message indicates that the mapping manner of a virtual RB to a physical RB is non-interleaved.

In an embodiment, the indication manner of the transmission information includes at least one of the following: expected or assumed by a terminal, predefined, indicated by an SIB1, indicated by an MIB, or indicated by DCI.

In an embodiment, when the indication manner of the transmission information includes MIB indication, the MIB indication bits may include reserved bits in the MIB, bits of existing fields in the MIB, and 2 bits in the payload of the physical broadcast channel (PBCH). In an embodiment, monitoring of the system message includes monitoring or detection.

In an embodiment, when the indication manner of the transmission information includes a DCI indication, the DCI is scrambled by a system information-radio network temporary identifier (SI-RNTI).

In an embodiment, when the indication manner of the transmission information includes a DCI indication, the DCI indication bits include legacy bits, high-order bits or low-order bits in the frequency domain resource assignment (FDRA) field.

In an embodiment, the transmission information may indicate the transmission information of the system message using a reserved field and/or an existing field in the DCI. The transmission information is configured to indicate transmission information of the system message received by a first type of terminal; and/or the existing field is configured to indicate transmission information of the system message received by a second type of terminal. The first type of terminal may be understood as a narrowband terminal. The second type of terminal may be understood as another terminal except narrowband terminals. That is, the DCI may be used to simultaneously indicate the transmission information of the system message of the first type of terminal and the second type of terminal.

In an embodiment, in the case where the bandwidth of the system message exceeds the maximum bandwidth of the first type of terminal, the system message is transmitted after being mapped in a specific mapping manner. Optionally, the specific mapping manner may be as follows: A first part of resources for transmitting the system message is mapped to a first symbol set and a first frequency domain resource set, where the first frequency domain resource set is a subset of a frequency domain resource set determined by the FDRA field in DCI, and the first symbol set is determined by the time domain resource assignment (TDRA) field in the DCI; and a second part of the resources for transmitting the system message is mapped to a second symbol set and a second frequency domain resource set, where symbols included in the second symbol set are after the first symbol set, and the second frequency domain resource set is a subset of the first frequency domain resource set.

FIG. 4 is another flowchart of the system message transmission method according to an embodiment of the present application. As shown in FIG. 4, the method in this embodiment is applicable to a terminal device. The method may include the following:

In S401, transmission information of a system message is acquired.

In S402, the system message is received according to the transmission information.

In an embodiment, the system message may be repeatedly transmitted according to the transmission information. In the case of repeatedly transmitting the system message, the preceding transmission information may include at least one of the following: the period of repetition transmissions of the system message, the number of repetition transmissions of the system message, the time window for repetition transmissions of the system message, position information for repetition transmissions of the system message, PDCCH occasion information, OSI message type information, system message index information, monitoring time period information within a system message window, monitoring position information within a system message window, or periodic pattern information for the system message.

In an embodiment, the transmission information may include terminal type information supported by a cell. In the case where the cell allows a first type of terminal to access, the frequency domain bandwidth of the system message transmission of the first type of terminal may be limited, that is, the frequency bandwidth of the system message transmission does not exceed the maximum bandwidth of the first type of terminal; the mapping manner of a virtual RB to a physical RB of the system message is non-interleaved; and DCI scheduling a PDSCH carrying the system message indicates that the mapping manner of a virtual RB to a physical RB is non-interleaved.

In an embodiment, the indication manner of the transmission information includes at least one of the following: expected or assumed by a terminal, predefined, indicated by an SIB1, indicated by an MIB, or indicated by DCI.

In an embodiment, when the indication manner of the transmission information includes MIB indication, the MIB indication bits may include reserved bits in the MIB, bits of existing fields in the MIB, and 2 bits in the payload of the PBCH.

In an embodiment, monitoring of the system message includes monitoring or detection.

In an embodiment, when the indication manner of the transmission information includes a DCI indication, the DCI is scrambled by an SI-RNTI.

In an embodiment, when the indication manner of the transmission information includes a DCI indication, the DCI indication bits include legacy bits, high-order bits or low-order bits in the FDRA field.

In an embodiment, the transmission information may indicate the transmission information of the system message using a reserved field and/or an existing field in the DCI. The transmission information is configured to indicate transmission information of the system message received by a first type of terminal; and/or the existing field is configured to indicate transmission information of the system message received by a second type of terminal. The first type of terminal may be understood as a narrowband terminal, such as a redcap terminal. The second type of terminal may be understood as another type of terminal other than narrowband terminals, such as an NR enhanced mobile broadband (eMBB) terminal. That is, the DCI may be used to simultaneously indicate the transmission information of the system message of the first type of terminal and the second type of terminal.

In an embodiment, in the case where the bandwidth of the system message exceeds the maximum bandwidth of the first type of terminal, the system message is transmitted after being mapped in a specific mapping manner. Optionally, the specific mapping manner may be as follows: A first part of resources for transmitting the system message is mapped to a first symbol set and a first frequency domain resource set, where the first frequency domain resource set is a subset of a frequency domain resource set determined by the FDRA field in DCI, and the first symbol set is determined by the TDRA field in the DCI; and a second part of the resources for transmitting the system message is mapped to a second symbol set and a second frequency domain resource set, where symbols included in the second symbol set are after the first symbol set, and the second frequency domain resource set is a subset of the first frequency domain resource set.

Some example embodiments are listed below to illustrate the system message transmission method in the preceding embodiments of the present application. The example embodiments below may be implemented independently or in combination.

In a first example embodiment, a network side device may repeatedly transmit the system message according to the transmission information, and a terminal device repeatedly receives the system message based on the transmission information. In this case, the transmission information may include at least one of the following: the period of repetition transmissions of the system message, the number of repetition transmissions of the system message, the time window for repetition transmissions of the system message, position information for repetition transmissions of the system message, PDCCH occasion information, OSI message type information, system message index information, monitoring time period information within a system message window, monitoring position information within a system message window, or periodic pattern information for the system message.

Next, each piece of transmission information for repeated transmission of the system message is introduced in turn.

The period of repetition transmissions of the system message refers to the repeated transmission of the system message according to the period of repetition transmissions within M units of time of the system message. Exemplarily, within one M units of time of the system message, the period of repetition transmissions E may be 5, 10, 15, 20, 40, 80, or 160, where the unit of E is slots, ms, us, s, or SFNs. Meanwhile, the corresponding period of repetition transmissions may also be indicated by 1 bit, 2 bits, or 3 bits in the SIB1, SIB, MIB, or DCI, and the indicated value includes at least one of the following: {5, 10, 15, 20, 40, 80, 160}. The DCI may be scrambled by an SI-RNTI. M may be determined based on any one of 160 ms, 80 ms, an SSB period, an SSB update period, a predefined value, a time window, ms, us, s, or slots. The value of M may be at least one of the following: {5, 10, 15, 20, 40, 80, 160}.

Exemplarily, it is assumed that within 160 ms of the system message, the period of repetition transmissions E is 20 ms. In this case, the system message is repeatedly transmitted within each period or periodic position of 20 ms. The system message may be the SIB1 or OSI.

The number of repeated transmissions of the system message refers to multiple repeated transmissions of the system message within M units of time. Exemplarily, the SIB1 system message is repeatedly sent 4 or 8 times within an SIB1 update period. M units of time are consistent with the definition of the preceding embodiment.

The time window for repeated transmissions of the system message refers to the repeated transmissions of the system message within the time window. For example, the length of the time window may include at least one of the following: 5 ms, 10 ms, 20 ms, 40 ms, 60 ms, and 160 ms. Optionally, the time window for repetition transmissions of the system message is determined based on at least one of the following: the time window of the system message, the transmission period of the system message, the system frame number (SFN), the slot number, the half-frame number, the cell identity (cell ID), or the bandwidth part identity (BWP), or predefined X ms, X μs, X slots, or X frames, where X is greater than or equal to 0.

Exemplarily, when the length of the time window of the system message is X ms (for example, 20 ms), the starting position of the time window for repeated transmissions of the system message may be the same as the starting position of the time window of the system message, and the length of the time window for repeated transmissions of the system message may be X/C, where C is a predefined, configured, or indicated coefficient. In this case, the system message starts from the starting position and is repeatedly transmitted within the length X/C of the time window.

Exemplarily, when the length of the time window of the system message is X ms (for example, 20 ms), the end position of the time window for repeated transmissions of the system message may be the same as the end position of the time window of the system message, and the length of the time window for repeated transmissions of the system message may be X/C, where C is a predefined, configured, or indicated coefficient. In this case, the system message is repeatedly transmitted within the length of the time window X/C based on the end position.

Exemplarily, when the length of the time window of the system message is X ms (for example, 20 ms), the starting position of the time window for repeated transmissions of the system message may be different from the starting position of the time window of the system message, and the starting position is predefined or indicated by the DCI, SIB, or MIB.

Exemplarily, when the length of the time window of the system message is X ms (for example, 20 ms), the length of the time window for repeated transmissions of the system message is a predefined value, a predefined value obtained based on the length of the time window of the system message, or indicated by the DCI, SIB, or MIB.

Exemplarily, the time window for repeated transmissions of the system message can be determined according to the transmission period of the system message and the starting position or duration of the time window for repeated transmissions of the system message also can be determined according to the transmission period of the system message. For example, the time window for repeated transmissions of the system message is defined within an odd or even period, within a predefined period, within a period under a predefined rule, or within an indicated period.

Exemplarily, the time window for repeated transmissions may be obtained by using the system frame number, or a time period between two radio frames is obtained by performing a modulo operation using the system frame number, and the time window for repeated transmissions of the system message is obtained based on the time period or is equal to the time period. For example, if SFN mod 20=0, then the radio frames where the SFN equals 20 and 40 constitute the time window for repeated transmissions of the system message.

Exemplarily, the length of the time window of the system message is X ms, and the position where the slot number is an even number or an odd number is the PDCCH for repeated transmissions.

Exemplarily, the time window for repeated transmissions of the system message is defined in the initial downlink BWP where BWP ID=0 or defined in other BWPs indicated by the SIB, DCI, or MIB.

Exemplarily, the time window for repeated transmissions of the system message may be determined based on multiple manners. Optionally, the time window for repeated transmissions of the system message is on the BWP where BWP ID=0 and is defined within the time window of the system message. Optionally, the time window for repeated transmissions of the system message is on the BWP where BWP ID=0 and is defined within the time window of a certain period of the system message. Optionally, the time window for repeated transmission of the system message is on the BWP where BWP ID=0 and is defined within the time window of a certain period of the system message, and the length of the time window for repeated transmissions of the system message may be 10 slots.

Exemplarily, the definition of the time window for repeated transmissions of the system message is related to the cell ID. For example, the first time window for repeated transmissions corresponds to when the cell ID modulo operation equals 1; the second time window for repeated transmissions corresponds to when the cell ID modulo operation equals 0, and so on. The position information for repeated transmissions of the system message refers to repeated transmissions of the system message at certain specified positions. Optionally, the position information for repetition transmissions is determined based on at least one of the following: a predefined position, a predefined coefficient, a predefined value, an SIB1 update period, 160 ms, a synchronization signal block (SSB) update period, 80 ms, an SSB period, the length of a time window of the system message, a transmission period of the system message, or Y units of time, where Y is a positive integer, and the Y units of time include ms, μs, s, slot, SSB period, SIB1 update period, 160 ms, SSB update period or 80 ms. Optionally, the position information for repeated transmissions may be indicated by a bitmap, and the size of the bitmap is related to the preceding period, Y units of time, or the time window of the system message.

Exemplarily, within the time window of the system message, the predefined positions for repetition transmissions may be at the ½, ¼, or ⅛ positions of the slot-based time window. ½, ¼, and ⅛ are predetermined coefficients or predefined values.

Exemplarily, within Y units of time, the predefined positions for repetition transmissions may be at the ½, ¼, or ⅛ positions of the time window based on Y units of time. For example, Y is 80 ms or 160 ms, where ½, ¼, and ⅛ are predetermined coefficients or predefined values.

Exemplarily, the length of the time window of the system message is 20 slots, the size of the bitmap may be 4 bits, and each bit indicates 5 slots. The 5 slots are PDCCH occasions that can be used to send the PDCCH that schedules the PDSCH carrying the repeated system message.

Exemplarily, the period of the system message is 32 radio frames, the size of the bitmap may be 2 bits, and each bit indicates whether the PDCCH occasion within 1 period frame is used to send repeated PDCCHs. That is, 2 bits indicate, among 64 radio frames or between two periodic positions, which period's PDCCH occasion is used to send the PDCCH that schedules the PDSCH carrying the repeated system message.

The PDCCH occasion information may include at least one of the number, slot, starting position, symbol, and SFN of the PDCCH occasion. The SIB1s decoded in a certain number of PDCCH occasions may be merged, and the number of PDCCH occasions includes at least one of the following: 1, 2, 4, 6, 8, 10, 12, 16, and 32. The slot of the PDCCH occasion is used to determine on which PDCCH occasion the system message is repeatedly scheduled by the PDCCH. The slot of the preceding PDCCH occasion is two slots determined based on the association between the type0-PDCCH common search space (CSS) and the synchronization signal block index (SSB index). The preceding slot indication may be a 2-bit pattern or a 1-bit indication, where the 1-bit indication is used to indicate that the slot of the PDCCH occasion is the first or second of the preceding two slots.

Optionally, the PDCCH occasion information includes the PDCCH occasion information within the time window of the system message, the PDCCH occasion information within the period of the system message, and the PDCCH occasion information within a period of time. The PDCCH occasion information is used to determine the slot position and/or symbol position where the PDCCH is sent.

Exemplarily, the PDCCH occasion of slot no or slot (n0+1) is used to transmit the PDCCH that schedules the repeated system message; 1 bit in the SIB1, MIB, or DCI may be used to indicate whether the PDCCH occasion is slot n0 or slot (n0+1).

Exemplarily, the last 2 PDCCH occasions within the time window of the system message are used to transmit the PDCCH that schedules the repeated system message.

The OSI message type information is used to indicate that the indicated type of system message is allowed to be transmitted repeatedly. Optionally, the OSI message type information is indicated by at least one of the following manners: Z bits indicate one or more pieces of OSI message type information, where Z is a positive integer, bitmap indication is used, and 1 bit corresponds to one type of system message.

For example, the OSI message type includes SIB2 to SIB14. When Z bits are used to indicate one or more pieces of OSI message type information, optionally, 4≤Y≤13, each state indicated by Z bits may correspond to one type of system message, or each state corresponds to an index value, and the index value points to the corresponding type of system message. When the OSI message type information is indicated by a bitmap, the length of the bitmap may be 13 bits. If a bit in the bitmap is 0, it indicates that the system message scheduled by the PDCCH does not have the type of system message corresponding to the bit, and the type of system message corresponding to the bit does not need to be repeatedly transmitted. Conversely, if a bit in the bitmap is 1, it indicates that the system message scheduled by the PDCCH has the type of system message corresponding to the bit, and the type of system message corresponding to the bit needs to be repeatedly transmitted.

System message index information refers to the repeated transmissions of the system message corresponding to the index information. Optionally, in the case where the transmission information includes the system message index information, a system message or a PDSCH carrying the system message is the same or repeated corresponding to a same index.

Exemplarily, the index includes 0 to 11, corresponding to SIB2 to SIB13 respectively. For the system message scheduled by the DCI, the system message indicated by index 0 is the same or repeated (for example, SIB2 corresponding to index 0 is the same or repeated).

Exemplarily, the index includes 0 to 11, and the bitmap corresponds to SIB2 to SIB13, respectively. Assuming that the bitmap indication in the DCI is 110000000000, it indicates that the scheduled system messages SIB2 and SIB3 are the same or repeated.

Exemplarily, the index includes 0 to 11, corresponding to SIB2 to SIB 13 respectively. For the PDSCH scheduled by the DCI, the PDSCH indicated by index 0 is the same or repeated. The PDSCH being the same or repeated includes the scenario where multiple PDSCHs scheduled by multiple PDCCHs are repeated (in this case, one PDCCH schedules one PDSCH), or multiple PDSCHs scheduled by a single PDCCH are repeated. The number of repetitions of the PDSCH needs to be indicated.

The monitoring time period information within a system message window refers to the repeated transmissions of the system message of this type in a certain monitoring time period in the system message window. Optionally, the monitoring time period information within a system message window may include starting position information and time length information. The starting position information is one or more starting positions defined based on the window length of the type of the system message, and the time length information may include at least one of the following: A ms, A slots, A radio frames, and A us, where A equal to one or more of s5, s10, s20, s40, s8, s10, s160, s320, s640, and s1280.

Exemplarily, the starting position defaults to the first slot, the last slot, or (c0+c*5) slots, where c0 is equal to 1 or other values, and c is an integer greater than or equal to 0; alternatively, the starting position is indicated by the DCI, MIB, or SIB. For example, the number of indicated bits is less than or equal to ┌log2 (A)┐ bits. For example, assuming A=5, 3 bits may be used to indicate which slot is the starting position.

Exemplarily, the starting position and/or time length information may be obtained according to the window length of the system message. For example, when the window length of the system message is 5, the starting position may be the 2nd slot, and the time length information may be 4 slots. When the window length of the system message is H, the starting position may be the H-3rd slot, and the time length information may be 4 slots. When the window length of the system message is H, the starting position may be the (H-K+1)-th slot, and the time length information may be K slots.

Exemplarily, the time length information is 5 slots, the starting position is obtained according to the indication information, and the number of indicated bits is obtained according to the window length of the system message. For example, when the window length of the system message is 5, the number of indicated bits is 1; when the window length of the system message is 10, the number of indicated bits is 2, and so on.

The monitoring position information within a system message window refers to monitoring the system message at a designated position in the system message window. Optionally, the monitoring position information may include at least one of the following: the n-th slot in the window, the n-th slot, the (n+b)-th slot, the (n+2b)-th slot to the (n+i*b)-th slot in the window, where n is greater than or equal to 0, i is greater than or equal to 0, and (n+i*b) is less than or equal to the window length.

Exemplarily, when the window length of the system message is 5, n=1, and b=2, it indicates that the 1st, 3rd, and 5th slots are designated positions for sending the PDCCH that schedules the repeated system message.

Exemplarily, in any window, n=5, and b=5, indicating that the 5th slot, 10th slots to the (5th+5i)-th slot are designated positions for sending the PDCCH that schedules the repeated system message, where (5+5i) is less than or equal to the window length of the system message.

The periodic pattern information for the system message is used to determine whether one or more periods of the system message require monitoring of the system message. That is, through this period pattern information, it is possible to know which periods require monitoring of the system message and which periods do not require monitoring of the system message. Optionally, some system messages may be monitored at intervals of G periods, where G is a positive integer greater than or equal to 1.

For example, when G=3, it indicates that the system message does not need to be monitored during the first, second, and third periods, while the system message in the fourth period needs to be monitored and/or the system message transmitted during that period is a repeated message.

Exemplarily, the periodic pattern is indicated using F bits, where F also represents the length of the repeating period. For example, when F=4, it indicates that the period repeats every four periods. If the 4-bit indication is 1001, it indicates that the system message does not need to be monitored in the second and third periods, while the system message needs to be monitored in the first and fourth periods and/or the system message transmitted during the first and fourth periods is a repeated message, and this pattern repeats every four periods.

Optionally, the preceding indication manner of the transmission information for repeated transmissions of the system message may include at least one of the following: expected or assumed by a terminal, predefined, indicated by an SIB1, indicated by an MIB, or indicated by DCI.

The MIB indication may include MIB reserved bit indication, MIB existing field indication, or PBCH payload indication. The DCI is scrambled by an SI-RNTI.

In this manner, the network side device repeatedly transmits the system message through at least one of the preceding transmission information. After the terminal device acquires the corresponding transmission information, the terminal device may repeatedly receive the system message based on the corresponding transmission information, which can ensure that the terminal device correctly receives the system message as much as possible and improve the system communication performance.

In a second example embodiment, the frequency domain bandwidth of the system message transmission may be limited so that the terminal device can receive the system message as completely as possible within the maximum bandwidth of the terminal device. Optionally, the preceding transmission information includes terminal type information supported by a cell. The terminal type information may include a first type of terminal and a second type of terminal. The first type of terminal may be understood as a narrowband terminal. The second type of terminal may be understood as another type of terminal except narrowband terminals.

When the transmission information includes the terminal type information supported by a cell, transmitting the system message according to the transmission information includes at least one of the following:

In the case where the cell allows a first type of terminal to access, the frequency bandwidth of the system message transmission does not exceed the maximum bandwidth of the first type of terminal.

The mapping manner of a virtual resource block (RB) to a physical RB of the system message is non-interleaved.

DCI scheduling a PDSCH carrying the system message indicates that the mapping manner of a virtual RB to a physical RB is non-interleaved.

For example, when the cell allows a first type of terminal to access, the frequency domain bandwidth of the system message transmission may be limited, and even the frequency domain bandwidth of the system message transmission does not exceed the maximum bandwidth of the first type of terminal. An example is used where the transmission information is indicated by DCI. Exemplarily, it is assumed that the maximum bandwidth of the first type of terminal is 5M. If the subcarrier spacing (subCarrierSpacingCommon) indicates scs15, the terminal device receives the MIB on the FRI frequency band, and meanwhile, the number of RBs configured in CORESET #0 is 48 or 96, then the number of frequency domain RBs indicated by the frequency domain resource allocation (FDRA) field in the DCI needs to be less than or equal to 25, or the frequency domain bandwidth indicated by the DCI needs to be less than or equal to 5 M. In this manner, the terminal device can receive the system message as completely as possible within the maximum bandwidth of the terminal device. The RB resources in the frequency domain may be continuous or discontinuous.

In this example, if the number of RBs indicated by the DCI is greater than 25 or the frequency domain bandwidth is greater than 5 M, it can be considered that the network side does not allow the first type of terminal to access. If the SIB1 or MIB indicates that the first type of terminal can access the network, but the number of CORESET #0 RBs indicated by DCI is greater than 25, the first type of terminal needs to have the ability to repeatedly receive the system message to access the network or the first type of terminal has this ability by default.

Exemplarily, if subCarrierSpacingCommon indicates scs30, the terminal device receives the MIB on the FRI frequency band, and the number of RBs configured in CORESET #0 is 24 or 48, then the number of frequency domain RBs indicated by the FDRA field in the DCI needs to be less than or equal to 11 or 12, or the frequency domain bandwidth indicated by the DCI needs to be less than or equal to 5 M. In this manner, the terminal device can receive the system message as completely as possible within the maximum bandwidth of the terminal device. The RB resources in the frequency domain may be continuous or discontinuous.

In this example, if the number of RBs indicated by the network side is greater than 11 or 12, or the frequency domain bandwidth is greater than 5 M, it can be considered that the network side does not allow the first type of terminal to access. If the SIB1 or MIB indicates that the first type of terminal can access the network, but the number of CORESET #0 RBs indicated by DCI is greater than 11 or 12, the first type of terminal needs to have the ability to repeatedly receive the system message to access the network or the first type of terminal has this ability by default.

In this embodiment, the frequency domain bandwidth of the system message transmission is limited, and the frequency domain bandwidth of the system message transmission does not exceed the maximum bandwidth of the first type of terminal. In this manner, the first type of terminal can receive the system message as completely as possible within the maximum bandwidth of the first type of terminal, thereby improving the success rate of system message reception.

In a third example embodiment, in the case where the system message exceeds the maximum bandwidth of the first type of terminal, the system message may be transmitted after being mapped in a specific mapping manner. The specific mapping manner enables the first type of terminal to receive the system message as completely as possible within the maximum bandwidth of the first type of terminal.

Optionally, the specific mapping manner includes the following: A first part of resources for transmitting the system message is mapped to a first symbol set and a first frequency domain resource set, where the first frequency domain resource set is a subset of a frequency domain resource set determined by the FDRA field in DCI, and the first symbol set is determined by the TDRA field in the DCI; and a second part of the resources for transmitting the system message is mapped to a second symbol set and a second frequency domain resource set, where symbols included in the second symbol set are after the first symbol set, and the second frequency domain resource set is a subset of the first frequency domain resource set.

The preceding specific mapping manners may be explained in different cases as follows:

In the first case, the MIB is received in the FRI frequency band, the subcarrier spacing is 15 Khz, the number of RBs configured in CORESET #0 is 48, and the frequency domain resource set C determined by the FDRA field in DCI is greater than 25 and less than or equal to 48.

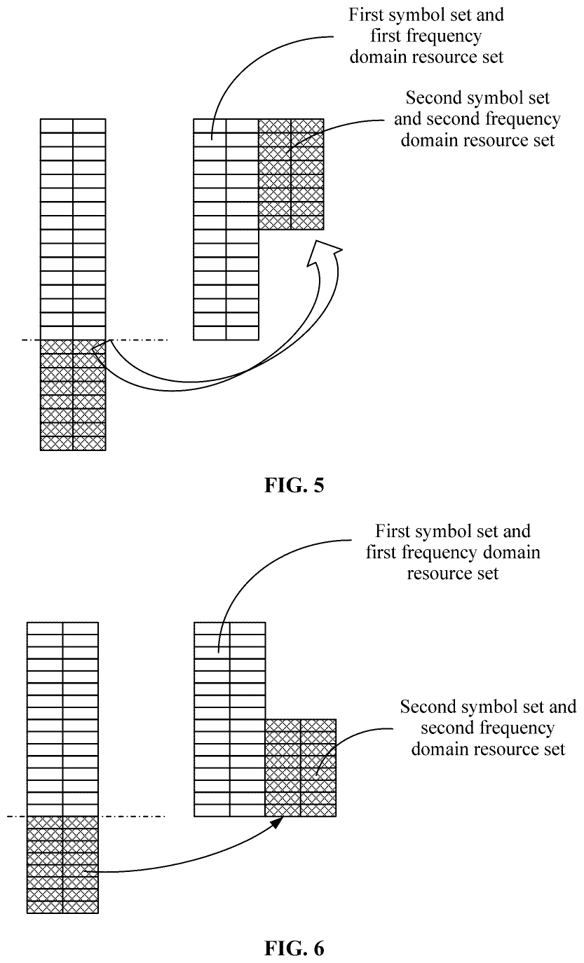

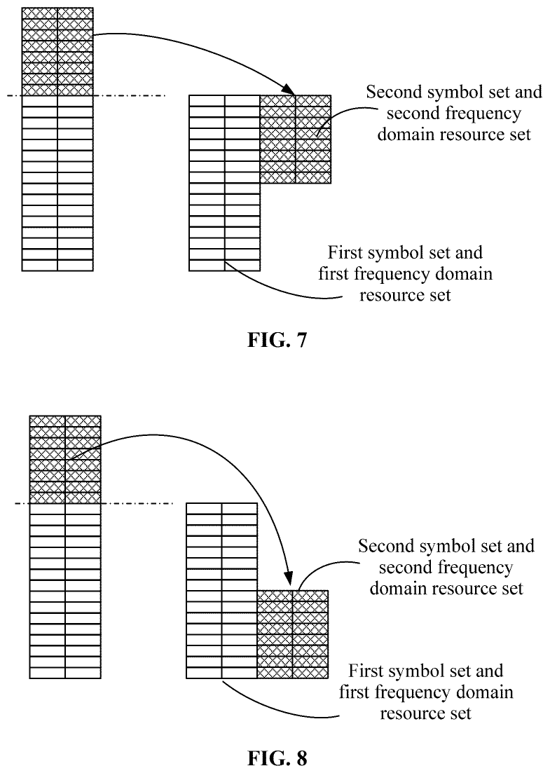

In the first case, as shown in FIGS. 5 to 8, the mapping positions of D RBs out of C RBs are kept unchanged and continue to be mapped to the first symbol set and the first frequency domain resource set, and the remaining RBs in the C RBs, except for the D RBs, are mapped to the second symbol set and the second frequency domain resource set. D matches the maximum bandwidth of the first type of terminal, and the value of D in the first case is 24 or 25.

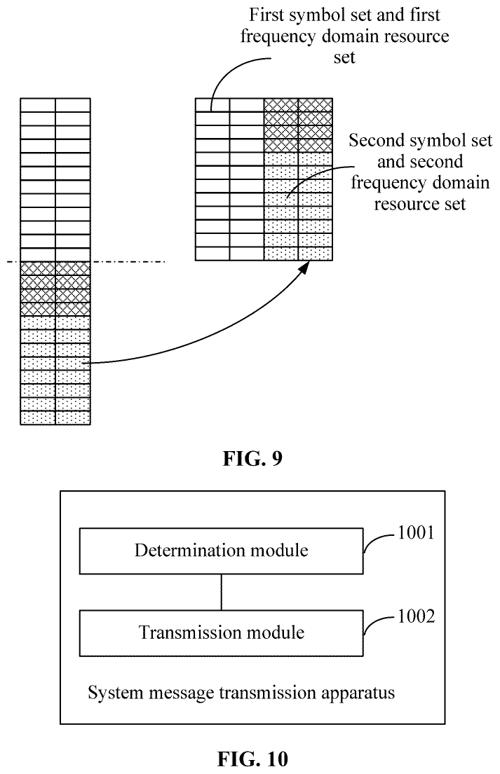

Alternatively, as shown in FIG. 9, the mapping positions of C/2 RBs in the C RBs remain unchanged and continue to be mapped to the first symbol set and the first frequency domain resource set, and the remaining C/2 RBs are mapped to the second symbol set and the second frequency domain resource set.

In the second case, the MIB is received in the FRI frequency band, the subcarrier spacing is 15 Khz, the number of RBs configured in CORESET #0 is 96, and the frequency domain resource set C determined by the FDRA field in DCI is greater than 25 and less than or equal to 96.

In the second case, the mapping positions of the RBs numbered 0 to (D-1) out of the C RBs are kept unchanged and continue to be mapped to the first symbol set and the first frequency domain resource set, the RBs numbered D to (2D-1) are mapped to the second symbol set and the second frequency domain resource set, and the RBs numbered 2D to (C-1) are mapped to a third symbol set and a third frequency domain resource set; alternatively, the mapping positions of the RBs numbered 0 to (C/3-1) out of the C RBs are kept unchanged and continue to be mapped to the first symbol set and the first frequency domain resource set, the RBs numbered C/3to (2*C/3-1) are mapped to the second symbol set and the second frequency domain resource set, and the RBs numbered (2*C/3) to (C-1) are mapped to the third symbol set and the third frequency domain resource set. The symbols included in the second symbol set are after the first symbol set, the symbols included in the third symbol set are after the second symbol set, and the second frequency domain resource set and the third frequency domain resource set are subsets of the first frequency domain resource set. D matches the maximum bandwidth of the first type of terminal, and the value of D in the second case is 24 or 25.

In the third case, the MIB is received in the FRI frequency band, the subcarrier spacing is 30 Khz, the number of RBs configured in CORESET #0 is 24, and the frequency domain resource set C determined by the FDRA field in DCI is less than or equal to 24.

In the third case, the mapping positions of D RBs out of the C RBs are kept unchanged and continue to be mapped to the first symbol set and the first frequency domain resource set, and the remaining RBs in the C RBs except the D RBs are mapped to the second symbol set and the second frequency domain resource set; alternatively, the mapping positions of the RBs numbered P to (P+D-1) in the C RBs are kept unchanged and continue to be mapped to the first symbol set and the first frequency domain resource set, and the RBs numbered (P+D) to(P+2*D-1) are mapped to the second symbol set and the second frequency domain resource set, or the RBs numbered (P+D) to (C-1) are mapped to the second symbol set and the second frequency domain resource set. D matches the maximum bandwidth of the first type of terminal. In the third case, the value of D is 11 or 12, and P is the starting RB number.

In the fourth case, the MIB is received in the FR1 frequency band, the subcarrier spacing is 30 Khz, the number of RBs configured in CORESET #0 is 48, and the frequency domain resource set C determined by the FDRA field in DCI is less than or equal to 48.

In the fourth case, the mapping positions of the RBs numbered P to (P+D-1) in the C RBs are kept unchanged and continue to be mapped to the first symbol set and the first frequency domain resource set, and the RBs numbered P+D to (P+2*D-1) are mapped to the second symbol set and the second frequency domain resource set, the RBs numbered P+2*D to (P+3*D−1) are mapped to the third symbol set and the third frequency domain resource set, the RBs numbered P+3*D to (P30 4*D-1) are mapped to a fourth symbol set and a fourth frequency domain resource set, and the RBs numbered P +4*D to C-1 are mapped to a fifth symbol set and a fifth frequency domain resource set, where D matches the maximum bandwidth of the first type of terminal, and in the fourth case, the value of D is 11 or 12, and P is the starting RB number.

Optionally, the preceding second symbol set may be indicated by DCI, indicated by the MIB, predefined, or determined according to the first symbol set.

The preceding third symbol set may be indicated by DCI, indicated by the MIB, predefined, determined according to the first symbol set, or determined according to the second symbol set.

The preceding fourth symbol set may be indicated by DCI, indicated by the MIB, predefined, determined according to the first symbol set, determined according to the second symbol set, or determined according to the third symbol set.

The preceding fifth symbol set may be indicated by DCI, indicated by the MIB, predefined, determined according to the first symbol set, determined according to the second symbol set, determined according to the third symbol set, or determined according to the fourth symbol set.

In this embodiment, when the bandwidth of the system message exceeds the maximum bandwidth of the first type of terminal, the system message is transmitted after being mapped in a specific mapping manner so that the first type of terminal can receive the system message as completely as possible within the maximum bandwidth of the first type of terminal, thereby improving the success rate of system message reception.

In a fourth example embodiment, the DCI that schedules the system message may be redefined so that the DCI contains the transmission information of the system message of the first type of terminal. Based on this, when the transmission information of the system message is indicated by the DCI, the transmission information is used to indicate the transmission information of the system message received by the first type of terminal.

Optionally, the transmission information of the system message may be indicated using a reserved field and/or an existing field in the DCI.

The DCI includes the reserved field and the existing field. The TDRA information, modulation and coding scheme (MCS) information, and FDRA information of the first type of terminal may be indicated by the reserved field. The transmission information of the system message received by the second type of terminal may be indicated by the existing field. The first type of terminal and the second type of terminal share the mapping manner of VRB to PRB in the DCI, the system message indication information, and the redundant version information. Optionally, the FDRA information indicated by the reserved field does not exceed the maximum bandwidth of the first type of terminal.

Optionally, indicating FDRA information using the legacy field in the DCI includes at least one of the following:
(1) The starting position is the same as that in the FDRA information in the existing field, and the legacy bit indicates the number of RBs used.
(2) The legacy bit indicates the starting RB, and the number of RBs defaults to the number of RBs corresponding to the maximum bandwidth of the first type of terminal.
(3) The starting position is the same as that in the FDRA information in the existing field, the number of RBs corresponding to the maximum bandwidth of the first type of terminal is used by default, and the frequency domain bandwidth and position are determined in a predefined manner.

In an embodiment, 1 bit in the legacy field in DCI may also be used to indicate whether transmission information of the system message of the first type of terminal exists in the DCI.

In an embodiment, the scheduling delay of the system message indicated by the TDRA information needs to be greater than a preset threshold, or the position indicated by the TDRA information is not in the same slot as the PDCCH, where the preset threshold is the minimum delay between the PDSCH and the PDCCH.

For example, if the scheduling delay indicated by the TDRA information is less than or equal to the preset threshold, the system message is scheduled according to the delay of the preset threshold. If the scheduling delay indicated by the TDRA information is greater than the preset threshold, scheduling is performed according to the delay indicated by the TDRA information. That is, the scheduling delay indicated by the TDRA information needs to meet the minimum delay between the PDSCH and the PDCCH.

In this embodiment, since the DCI includes the transmission information for the first type of terminal to receive the system message, the first type of terminal can receive the system message as completely as possible through the transmission information indicated by the DCI, thereby improving the success rate of the system message reception.

FIG. 10 is a diagram illustrating the structure of a system message transmission device according to an embodiment of the present application. As shown in FIG. 10, the device may include a determination module 1001 and a transmission module 1002.

For example, the determination module 1001 is configured to determine transmission information of a system message, and the transmission module 1002 is configured to transmit the system message according to the transmission information.

The system message transmission device provided by the embodiment is configured to implement the system message transmission method of the embodiment shown in FIG. 3. The implementation principle and effects of the system message transmission device provided by the embodiment are similar to those of the preceding embodiments and are not repeated here.

Based on the preceding embodiments, in an embodiment, the transmission module 1002 is configured to repeatedly transmit the system message according to the transmission information.

In an embodiment, the transmission information includes at least one of the following: the period of repetition transmissions of the system message, the number of repetition transmissions of the system message, the time window for repetition transmissions of the system message, position information for repetition transmissions of the system message, PDCCH occasion information, OSI message type information, system message index information, monitoring time period information within a system message window, monitoring position information within a system message window, or periodic pattern information for the system message.

In an embodiment, in the case where the transmission information includes the PDCCH occasion information, the system message carried on a PDSCH scheduled by the PDCCH sent according to the PDCCH occasion information is the same or repeated.

In an embodiment, in the case where the transmission information includes the time window for repetition transmissions of the system message, the time window for repetition transmissions of the system message is determined based on at least one of the following: a time window of the system message, a transmission period of the system message, the SFN, the slot number, the half-frame number, the cell ID, or the BWP ID, or X ms, X μs, X slots, or X frames, where X is greater than or equal to 0.

In an embodiment, in the case where the transmission information includes the position information for repetition transmissions of the system message, the position information for repetition transmissions is determined based on at least one of the following: a predefined position, a predefined coefficient, a predefined value, an SIB1 update period or 160 ms, an SSB update period or 80 ms, an SSB period, the length of a time window of the system message, a transmission period of the system message, or Y units of time, where Y is a positive integer, and the Y units of time include ms, μs, s, slot, SSB period, SIB1 update period, 160 ms, SSB update period or 80 ms.

In an embodiment, in the case where the transmission information includes the OSI message type information, the OSI message type information is indicated by at least one of the following manners: Z bits indicate one or more pieces of OSI message type information, where Z is a positive integer. Bitmap indication is used, where 1 bit corresponds to one type of system message.

In an embodiment, in the case where the transmission information includes the system message index information, a system message or a PDSCH carrying the system message is the same or repeated corresponding to a same index.

In an embodiment, in the case where the transmission information includes the monitoring time period information within the system message window, the monitoring time period information within the system message window includes starting position information and time length information.

In an embodiment, in the case where the transmission information includes the periodic pattern information for the system message, the periodic pattern information is configured to determine whether one or more periods of the system message require monitoring of the system message.

In an embodiment, the transmission information includes terminal type information supported by a cell.

In an embodiment, when the transmission information includes the terminal type information supported by a cell, transmitting the system message according to the transmission information includes at least one of the following:

In the case where the cell allows a first type of terminal to access, the frequency bandwidth of the system message transmission does not exceed the maximum bandwidth of the first type of terminal.

The mapping manner of a virtual RB to a physical RB of the system message is non-interleaved.

DCI scheduling a PDSCH carrying the system message indicates that the mapping manner of a virtual RB to a physical RB is non-interleaved.

In an embodiment, the indication manner of the transmission information includes at least one of the following: expected or assumed by a terminal, predefined, indicated by an SIB1, indicated by an MIB, or indicated by DCI.

In an embodiment, the DCI is scrambled by an SI-RNTI.

In an embodiment, the transmission information being indicated by the DCI includes indicating the transmission information of the system message using a reserved field and/or an existing field in the DCI.

In an embodiment, the transmission information includes at least one of the following: TDRA information, MCS information, or FDRA information.

In an embodiment, the transmission information is configured to indicate transmission information of the system message received by a first type of terminal; and/or, the existing field is configured to indicate transmission information of the system message received by a second type of terminal.

In an embodiment, in the case where the bandwidth of the system message exceeds the maximum bandwidth of the first type of terminal, the system message is transmitted after being mapped in a specific mapping manner.

In an embodiment, the specific mapping manner includes the following:

A first part of resources for transmitting the system message is mapped to a first symbol set and a first frequency domain resource set, where the first frequency domain resource set is a subset of a frequency domain resource set determined by an FDRA field in the DCI, and the first symbol set is determined by a TDRA field in the DCI.

A second part of the resources for transmitting the system message is mapped to a second symbol set and a second frequency domain resource set, where symbols included in the second symbol set are after the first symbol set, and the second frequency domain resource set is a subset of the first frequency domain resource set.

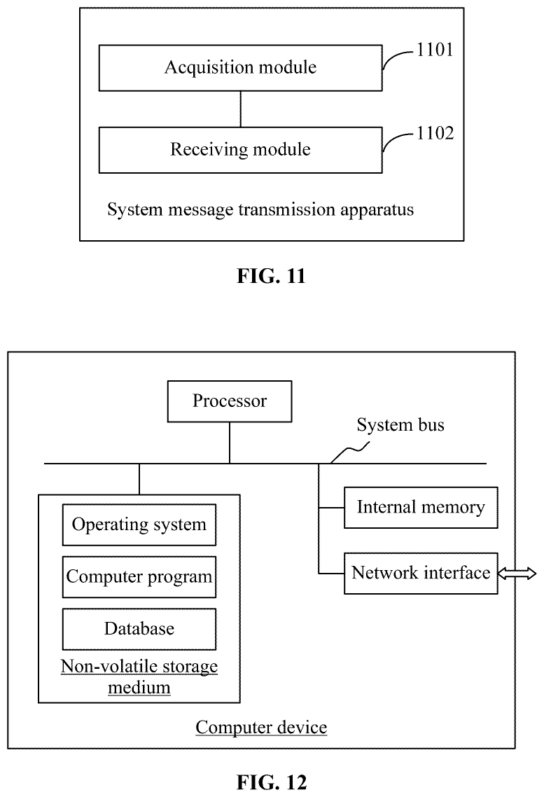

FIG. 11 is a diagram illustrating another structure of the system message transmission device according to an embodiment of the present application. As shown in FIG. 11, the device may include an acquisition module 1101 and a receiving module 1102.

For example, the acquisition module 1101 is configured to acquire transmission information of a system message, and the receiving module 1102 is configured to receive the system message according to the transmission information.

The system message transmission device provided by the embodiment is configured to implement the system message transmission method of the embodiment shown in FIG. 4. The implementation principle and effects of the system message transmission device provided by the embodiment are similar to those of the preceding embodiments and are not repeated here.

In an embodiment, the receiving module 1102 is configured to repeatedly receive the system message according to the transmission information.

In an embodiment, the transmission information includes at least one of the following: the period of repetition transmissions of the system message, the number of repetition transmissions of the system message, the time window for repetition transmissions of the system message, position information for repetition transmissions of the system message, PDCCH occasion information, OSI message type information, system message index information, monitoring time period information within a system message window, monitoring position information within a system message window, or periodic pattern information for the system message.

In an embodiment, in the case where the transmission information includes the time window for repetition transmissions of the system message, the time window for repetition transmissions of the system message is determined based on at least one of the following: a time window of the system message, a transmission period of the system message, the SFN, the slot number, the half-frame number, the cell ID, or the BWP ID, or X ms, X μs, X slots, or X frames, where X is greater than or equal to 0.

In an embodiment, in the case where the transmission information includes the system message index information, a system message or a PDSCH carrying the system message is the same or repeated corresponding to a same index.

In an embodiment, the indication manner of the transmission information includes at least one of the following: expected or assumed by a terminal, predefined, indicated by an SIB1, indicated by an MIB, or indicated by DCI.

In an embodiment, in the case where the transmission information includes the position information for repetition transmissions of the system message, the position information for repetition transmissions is determined based on at least one of the following: a predefined position, a predefined coefficient, a predefined value, an SIB1 update period or 160 ms, an SSB update period or 80 ms, an SSB period, the length of a time window of the system message, a transmission period of the system message, or Y units of time, where Y is a positive integer, and the Y units of time include ms, μs, s, slot, SSB period, SIB1 update period, 160 ms, SSB update period or 80 ms.

In an embodiment, in the case where the transmission information includes the OSI message type information, the OSI message type information is indicated by at least one of the following manners: Z bits indicate one or more pieces of OSI message type information, where Z is a positive integer. Bitmap indication is used, where 1 bit corresponds to one type of system message.

In an embodiment, in the case where the transmission information includes the monitoring time period information within the system message window, the monitoring time period information within the system message window includes starting position information and time length information.

In an embodiment, in the case where the transmission information includes the periodic pattern information for the system message, the periodic pattern information is configured to determine whether one or more periods of the system message require monitoring of the system message.

In an embodiment, in the case where the transmission information includes the PDCCH occasion information, the system message carried on a physical downlink shared channel (PDSCH) scheduled by the PDCCH sent according to the PDCCH occasion information is the same or repeated.

In an embodiment, the transmission information being indicated by the DCI includes indicating the transmission information of the system message using a reserved field and/or an existing field in the DCI.

In an embodiment, the transmission information includes at least one of the following: TDRA information, MCS information, or FDRA information.

In an embodiment, the transmission information is configured to indicate transmission information of the system message received by a first type of terminal; and/or the existing field is configured to indicate transmission information of the system message received by a second type of terminal.

In an embodiment, the DCI is scrambled by an SI-RNTI.

In an embodiment, the transmission information includes terminal type information supported by a cell.

In an embodiment, in the case where the transmission information includes the terminal type information supported by a cell, receiving the system message according to the transmission information includes: in the case where the cell allows a first type of terminal to access, receiving the system message according to the maximum bandwidth of the first type of terminal.

In an embodiment, in the case where the bandwidth of the system message exceeds the maximum bandwidth of the first type of terminal, the system message is mapped in a specific mapping manner.

In an embodiment, the specific mapping manner includes the following:

A first part of resources for transmitting the system message is mapped to a first symbol set and a first frequency domain resource set, where the first frequency domain resource set is a subset of a frequency domain resource set determined by an FDRA field in the DCI, and the first symbol set is determined by a TDRA field in the DCI.

A second part of the resources for transmitting the system message is mapped to a second symbol set and a second frequency domain resource set, where symbols included in the second symbol set are after the first symbol set, and the second frequency domain resource set is a subset of the first frequency domain resource set.

In an embodiment, a communication node is provided, and the internal structure of the communication node may be as shown in FIG. 12. The communication node includes a processor, a memory, a network interface, and a database that are all connected via a system bus. The processor of the communication node is used to provide computing and control capabilities. The memory of the communication node includes non-volatile storage media and internal memory. The non-volatile storage media stores an operating system, a computer program, and a database. The internal memory provides an environment for running the operating system and computer program stored in the non-volatile storage media. The database of the communication node is used to store data generated during the process of the system message transmission. The network interface of the communication node is used to communicate with an external terminal via a network connection. When executed by the processor, the computer program implements a system message transmission method.

It should be understood by those skilled in the art that the structure shown in FIG. 12 is only a block diagram of a partial structure related to the solution of the present application and does not constitute a limitation on the communication node to which the solution of the present application is applied. The specific communication node may include more or fewer components than those shown in the figure, combine certain components, or have a different component arrangement.

In an embodiment, a communication node is provided. The communication node may be a network side device and includes a memory and a processor. The memory stores a computer program, and the processor is configured to, when executing the computer program, implement the following operations:

Transmission information of a system message is determined.

The system message is transmitted according to the transmission information.

In an embodiment, a communication node is provided. The communication node may be a terminal device and includes a memory and a processor. The memory stores a computer program, and the processor is configured to, when executing the computer program, implement the following operations:

Transmission information of a system message is acquired.

The system message is received according to the transmission information.

In an embodiment, a storage medium is provided. The storage medium stores a computer program. The computer program, when executed by a processor, implements the following operations:

Transmission information of a system message is determined.

The system message is transmitted according to the transmission information.

In an embodiment, a storage medium is provided. The storage medium stores a computer program. The computer program, when executed by a processor, implements the following operations:

Transmission information of a system message is acquired.

The system message is received according to the transmission information.

A computer storage medium in this embodiment of the present application may adopt any combination of one or more computer-readable media. The computer-readable medium may be a computer-readable signal medium or a computer-readable storage medium. The computer-readable storage medium may be, for example, but is not limited to, an electrical, magnetic, optical, electromagnetic, infrared or semiconductor system, apparatus or device, or any combination thereof. The computer-readable storage medium includes (a non-exhaustive list) an electrical connection having one or more wires, a portable computer disk, a hard disk, a random access memory (RAM), a read-only memory (ROM), an electrically erasable programmable read-only memory (EPROM), a flash memory, an optical fiber, a portable compact disk read-only memory (CD-ROM), an optical memory, a magnetic memory, or any suitable combination thereof. In the present application, the computer-readable storage medium may be any tangible medium including or storing a program. The program may be used by or used in conjunction with an instruction execution system, apparatus, or device.

A computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal or any suitable combination thereof. The computer-readable signal medium may also be any computer-readable medium other than the computer-readable storage medium. The computer-readable medium may send, propagate, or transmit a program used by or used in conjunction with an instruction execution system, apparatus, or device.

Program codes included on the computer-readable medium may be transmitted by using any suitable medium including, but not limited to, a radio medium, a wire, an optical cable, and radio frequency (RF), or any suitable combination thereof.

Computer program codes for executing the operations of the present disclosure may be written in one or more programming languages or a combination of multiple programming languages. The programming languages include object-oriented programming languages (such as Java, Smalltalk, C++, Ruby and Go) and conventional procedural programming languages (such as “C” or similar programming languages). The program codes may be executed entirely on a user computer, partly on a user computer, as a stand-alone software package, partly on a user computer and partly on a remote computer, or entirely on a remote computer or a server. In the case where the remote computer is involved, the remote computer may be connected to the user computer via any type of network (including a local area network (LAN) or a wide area network (WAN)) or may be connected to an external computer (for example, via the Internet through an Internet service provider).

It is to be understood by those skilled in the art that the term user terminal encompasses any suitable type of wireless user device, for example, a mobile phone, a portable data processing apparatus, a portable web browser, or a vehicle-mounted mobile station.

Generally speaking, various embodiments of the present application may be implemented in hardware or special-purpose circuits, software, logic, or any combination thereof. For example, some aspects may be implemented in hardware while other aspects may be implemented in firmware or software executable by a controller, a microprocessor, or another calculation apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, state setting data, or source or object codes written in any combination of one or more programming languages.

A block diagram of any logic flow among the drawings of the present application may represent program procedures, may represent interconnected logic circuits, modules, and functions, or may represent a combination of program procedures with logic circuits, modules, and functions. Computer programs may be stored in a memory. The memory may be of any type appropriate for the local technical environment and may be implemented using any appropriate data storage technology, such as, but not limited to, a read-only memory (ROM), a random access memory (RAM), an optical storage apparatus and system (a digital versatile disc (DVD) or a CD), and the like. Computer-readable media may include non-transitory storage media. The data processor may be of any type suitable to the local technical environment, such as, but is not limited to, a general purpose computer, a special purpose computer, a microprocessor, a digital signal processing (DSP), an application specific integrated circuit (ASIC), a field-programmable gate array (FPGA), and a processor based on a multi-core processor architecture.

1. A system message transmission method, comprising:
determining transmission information of a system message; and
transmitting the system message according to the transmission information.

2. The method of claim 1, wherein transmitting the system message according to the transmission information comprises:
repeatedly transmitting the system message according to the transmission information.

3. The method of claim 2, wherein the transmission information comprises at least one of the following:
a period of repetition transmissions of the system message;
a number of repetition transmissions of the system message;
a time window for repetition transmissions of the system message;
position information for repetition transmissions of the system message;
physical downlink control channel (PDCCH) occasion information;
other system information (OSI) message type information for the system message;
system message index information;
monitoring time period information within a system message window;
monitoring position information within a system message window; or
periodic pattern information for the system message.

4. The method of claim 1, wherein in a case where the transmission information comprises the PDCCH occasion information, a system message carried on a physical downlink shared channel (PDSCH) scheduled by the PDCCH sent according to the PDCCH occasion information is the same or repeated;
or in a case where the transmission information comprises the time window for repetition transmissions of the system message, the time window for repetition transmissions of the system message is determined based on at least one of the following:
a time window of the system message, a transmission period of the system message, a system frame number (SFN), a slot number, a half-frame number, a cell identity (cell ID), a bandwidth part identity (BWP ID), or X ms, X μs, X slots, or X frames, wherein X is greater than or equal to 0;
or
in a case where the transmission information comprises the position information for repetition transmissions of the system message, the position information for repetition transmissions is determined based on at least one of the following:
a predefined position;
a predefined coefficient;
a predefined value;
an SIB1 update period or 160 ms;
a synchronization signal block (SSB) update period or 80 ms;
an SSB period;
a length of a time window of the system message;
a transmission period of the system message; or
Y units of time, wherein Y is a positive integer, and the units of time comprise ms, μs, s, slot, SSB period, SIB1 update period, 160 ms, SSB update period or 80 ms;
or
in a case where the transmission information comprises the OSI message type information, the OSI message type information is indicated by at least one of the following manners:
Z bits indicate one or more pieces of OSI message type information, wherein Z is a positive integer; or
bitmap indication is used, wherein 1 bit corresponds to one type of system message;
or
in a case where the transmission information comprises the system message index information, a system message or a PDSCH carrying the system message is the same or repeated corresponding to a same index;
or
in a case where the transmission information comprises the monitoring time period information within the system message window, the monitoring time period information within the system message window comprises starting position information and time length information;
or
in a case where the transmission information comprises the periodic pattern information for the system message, the periodic pattern information is configured to determine whether one or more periods of the system message require monitoring of the system message.

5-10. (canceled)

11. The method of claim 1, wherein the transmission information comprises terminal type information supported by a cell.

12. The method of claim 11, wherein in a case where the transmission information comprises the terminal type information supported by a cell, transmitting the system message according to the transmission information comprises at least one of the following:
in a case where the cell allows a first type of terminal to access, a frequency bandwidth of transmitting the system message is less than or equal to a maximum bandwidth of the first type of terminal;
a mapping manner of a virtual resource block (RB) to a physical RB of the system message is non-interleaved; or
downlink control information (DCI) scheduling a PDSCH carrying the system message indicates that a mapping manner of a virtual RB to a physical RB is non-interleaved.

13. The method of claim 1, wherein an indication manner of the transmission information comprises at least one of the following:
expected or assumed by a terminal, predefined, indicated by the SIB 1, indicated by a master information block (MIB), or indicated by the DCI.

14. The method of claim 12, wherein the DCI is scrambled by a system information-radio network temporary identifier (SI-RNTI).

15. The method of claim 13, wherein the transmission information being indicated by the DCI comprises:
indicating the transmission information of the system message using at least one of a reserved field or an existing field in the DCI.

16. The method of claim 15, wherein the transmission information comprises at least one of the following:
time domain resource assignment (TDRA) information, modulation and coding scheme (MCS) information, or frequency domain resource assignment (FDRA) information.

17. The method of claim 15, wherein at least one of the following is satisfied:
the transmission information is configured to indicate transmission information of the system message received by the first type of terminal;
or, the existing field is configured to indicate transmission information of the system message received by a second type of terminal.

18. The method of claim 12, wherein in a case where a bandwidth of the system message is greater than the maximum bandwidth of the first type of terminal, the system message is transmitted after being mapped in a specific mapping manner.

19. The method of claim 18, wherein the specific mapping manner comprises that:
a first part of resources for transmitting the system message is mapped to a first symbol set and a first frequency domain resource set, wherein the first frequency domain resource set is a subset of a frequency domain resource set determined by an FDRA field in the DCI, and the first symbol set is determined by a TDRA field in the DCI; and
a second part of the resources for transmitting the system message is mapped to a second symbol set and a second frequency domain resource set, wherein symbols comprised in the second symbol set are after the first symbol set, and the second frequency domain resource set is a subset of the first frequency domain resource set.

20. A system message transmission method, comprising:
acquiring transmission information of a system message; and
receiving the system message according to the transmission information.

21. The method of claim 20, wherein receiving the system message according to the transmission information comprises:
repeatedly receiving the system message according to the transmission information.

22. The method of claim 21, wherein the transmission information comprises at least one of the following:
a period of repetition transmissions of the system message;
a number of repetition transmissions of the system message;
a time window for repetition transmissions of the system message;
position information for repetition transmissions of the system message;
physical downlink control channel (PDCCH) occasion information;
other system information (OSI) message type information for the system message;
system message index information;
monitoring time period information within a system message window;
monitoring position information within a system message window; or periodic pattern information for the system message.

23. The method of claim 20, wherein
in a case where the transmission information comprises the time window for repetition transmissions of the system message, the time window for repetition transmissions of the system message is determined based on at least one of the following:
a time window of the system message, a transmission period of the system message, an SFN, a slot number, a half-frame number, a cell ID, or a BWP ID, or X ms, X μs, X slots, or X frames, wherein X is greater than or equal to 0;
or
in a case where the transmission information comprises the system message index information, a system message or a PDSCH carrying the system message is the same or repeated corresponding to a same index;
or
in a case where the transmission information comprises the position information for repetition transmissions of the system message, the position information for repetition transmissions is determined based on at least one of the following:
a predefined position;
a predefined coefficient;
a predefined value;
an SIB 1 update period or 160 ms;
an SSB update period or 80 ms;
an SSB period;
a length of a time window of the system message;
a transmission period of the system message; or Y units of time, wherein Y is a positive integer, and the units of time comprise ms, μs, s, slot, SSB period, SIB1 update period, 160 ms, SSB update period or 80 ms;
or
in a case where the transmission information comprises the OSI message type information, the OSI message type information is indicated by at least one of the following manners:
Z bits indicate one or more pieces of OSI message type information, wherein Z is a positive integer; or bitmap indication is used, wherein 1 bit corresponds to one type of system message:
or
in a case where the transmission information comprises the monitoring time period information within the system message window, the monitoring time period information within the system message window comprises starting position information and time length information;
or
in a case where the transmission information comprises the periodic pattern information for the system message, the periodic pattern information is configured to determine whether one or more periods of the system message require monitoring of the system message.
or
in a case where the transmission information comprises the PDCCH occasion information, a system message carried on a physical downlink shared channel (PDSCH) scheduled by the PDCCH sent according to the PDCCH occasion information is the same or repeated.

24. (canceled)

25. The method of any one of claims 20, wherein an indication manner of the transmission information comprises at least one of the following:
expected or assumed by a terminal, predefined, indicated by an SIB1, indicated by an MIB, or indicated by DCI;
wherein the transmission information being indicated by the DCI comprises:
indicating the transmission information of the system message using at least one of a reserved field or an existing field in the DCI.

26-34. (canceled)

35. The method of claim 20, wherein the transmission information comprises terminal type information supported by a cell.

36-40. (canceled)

41. A communication node, comprising a memory and a processor, wherein the memory stores a computer program, and the processor, when executing the computer program, is configured to implement operations of a system message transmission method, wherein the operations comprises:
determining transmission information of a system message; and
transmitting the system message according to the transmission information.

42. (canceled)
